(19) United States
(12) Patent Application Publication
(10) Pub. No.: US 2016/0129615 A1
(43) Pub. Date: May 12, 2016

(54) Method for Manufacturing Molded Foam Parts in a Packaging Sleeve and Sales Unit

(71) Applicant: Hilti Aktiengesellschaft, Schaan (LI)

(72) Inventors: Herbert Münzenberger, Wiesbaden (DE); Mario Paetow, Igling (DE); Andreas Ober, Kaufering (DE)

(21) Appl. No.: 14/996,325

(22) Filed: Jan. 15, 2016

Related U.S. Application Data
(63) Continuation of application No. PCT/EP2014/065465, filed on Jul. 18, 2014.

(30) Foreign Application Priority Data
Jul. 18, 2013 (EP) 13177002.6

(51) Int. Cl. B29C 44/14; B29C 67/24; B65B 3/02; B29C 33/68

(52) U.S. Cl. CPC B29C 44/146; B29C 33/68; B29C 67/246; B65B 3/022; B29K 2105/04

(57) ABSTRACT

A method for producing molded foam parts for construction and civil engineering has the following steps: Inserting a packaging sleeve of the molded foam part to be produced into a molding tool, filling a flowable foaming material into the packaging sleeve within molding tool, filling the cavity defined by molding tool and packaging sleeve with foam, and removing the molded foam part produced, together with its packaging sleeve.

### RELATED APPLICATIONS

This application claims priority to, and is a continuation of, co-pending International Application No. PCT/EP2014/065465 having an International filing date of Jul. 18, 2014, which is incorporated herein by reference, and which claims priority to European Patent Application No. 13177002.6, having a filing date of Jul. 18, 2013, which is also incorporated herein by reference in its entirety.

### BACKGROUND AND BRIEF SUMMARY OF THE INVENTION

The invention regards a process for manufacturing molded foam parts for construction and civil engineering, as well as a sales unit for a molded foam part.

Molded foam parts for construction and civil engineering are usually manufactured using the RIM process. Here, a flowable material is introduced into a molding tool in which it will complete its reaction, completely filling the cavity of a molding tool with foam. However, the foam will adhere to the surface of the molding tool upon completion of the reaction, which is why measures are taken to exclude such adhesion.

Different procedures are known for preventing adhesion of the foam to the molding tool and for facilitating removal from the mold. For example, a releasing agent can be sprayed in before each foaming process; however, this requires a total cleaning of the molding tool after 10 to 15 foaming processes.

An alternative is presented by a coated molding tool; however, the coating must be replaced after 100 to 150 foaming processes. This is expensive and in addition, it will change the dimensional precision of the molding tool.

Inserts made of silicone or polyolefins for the molding tool are also common; however, they also only have a limited lifespan of about 50 to 100 foaming processes.

Finally, releasing films can be used; however, they tend to wrinkle, so that they are only used on smooth surfaces.

The task of the invention is to provide a process for manufacturing molded foam parts that is both cost-effective and does not entail any interruption of the production process after a certain number of foaming processes.

This task is solved by a method for producing molded foam parts for construction and civil engineering, with the following steps:
inserting a packaging sleeve for the molded foam part to be manufactured into a molding tool;
filling a flowable foaming material into the packaging sleeve inside the molding tool;
filling the cavity defined by the molding tool and the packaging sleeve with foam; and
removing the produced molded foam part together with its packaging sleeve from the mold.

The invention is based on the recognition that the packaging sleeve can be used to prevent adhesion of the foaming material to the molding tool. This is achieved by the molded foam part completing its reaction inside the packaging sleeve that has been inserted into the molding tool beforehand. This prevents direct contact between the foaming material and the molding tool so that the foaming material cannot adhere to the molding tool. In addition, the process is cost-effective because there is no need for releasing agents, coatings or inserts that cause additional costs. Besides, the subsequent packaging of the molded part will no longer be necessary.

Preferably, the packaging sleeve will envelop the molded foam part completely, which will reliably prevent any contact between the foaming material and the molding tool.

In a variant of the embodiment, the packaging sleeve is embodied as having several parts; in particular, two parts. An upper part of the packaging sleeve will be inserted into an upper tool part of the molding tool, and a lower part of the packaging sleeve will be inserted into a lower tool part of the molding tool. This achieves in a simple manner that both the upper tool part as well as the lower tool part are protected from the adhesion of the foaming material.

The upper part and the lower part of the packaging sleeve can be fastened to each other as the molding tool is closed; in particular, by heating, which will realize a securely closed packaging sleeve in a simple manner.

For example, the packaging sleeve will be closed by the forming tool so that an additional process step for closing the packaging sleeve will not be required.

In one embodiment of the invention, the flowable foaming material is a reaction mass containing at least two components so that the two components can react with each other to form foam inside the molding tool.

Preferably, the reaction mass will react to form polyurethane foam, as polyurethane foam is a widely used material in construction and civil engineering.

In a variant of the embodiment, the flowable foaming material consists of a foamable binder containing an intumescent mix of substances. Here, the binder serves as an interlinking carrier for the intumescent mix of substances. Preferably, the binder will be homogeneously distributed within the binder. The interlinking carrier is preferably selected from among the group consisting of polyurethanes, phenolic resins, polystyrenes, polyolefins, such as polyethylene and/or polybutylene, melamine resins, melamine resin foams, synthetic and natural rubber, cellulose, elastomers, and mixtures thereof, with polyurethanes being preferred.

The ash-forming and, if applicable, intumescent mix of substances comprises the fire protection additives that are common and known to the person skilled in the art, which additives will, in case of fire, i.e., when exposed to heat, start foaming and thus form foam that will hinder the propagation of flames, such as an intumescent material based on an acidifier, a compound producing carbon, and a gasifier. Preferably, the intumescent material will comprise as an acidifier, a salt or an ester of an inorganic, non-volatile acid selected from among sulfuric acid, phosphoric acid and boric acid; as a compound producing carbon, a poly-hydroxyl compound and/or a thermoplastic or duroplastic polymer resin binder; and as a gasifier, a chloro-paraffin, melamine, a melamine compound, in particular, melamine cyanurate, melamine phosphate, melamine polyphosphate, tri(hydroxyethyl)-cyanurate, cyanamide, dicyanamide, dicyandiamide, biguanidin and/or a guanidin salt, in particular, guanidin phosphate or guanidin sulfate.

In addition, the interlinking carrier can contain, as an ablative additive—an inorganic compound that contains water in solid form, e.g. as crystallization water, and will not dry out at temperatures of up to 100° C., but will release the water in case of fire at temperatures from 120° C. on, thus being able to cool components; this will preferably be an inorganic hydroxide or hydrate, in particular, aluminum hydroxide, aluminum oxide hydrates or partially hydrated aluminum hydroxides, that releases water when exposed to the fire's temperature or to flames. But other inorganic hydroxides or hydrates releasing water when exposed to flames are also an option, such as those described in EP 0 274 068 A2.

Such compounds that can be used as mix of substances in the fire protection insert according to the invention, are known to the person skilled in the art and are, e.g., disclosed in the following citations, which are herewith expressly referenced: DE 30 25 309 A1, DE 30 41 731 A1, DE 33 02 416 A1, DE 34 11 327 A1, EP 0 043 952 B1, EP 0 051 106 B1, EP 0 061 024 B1, EP 0 116 846 B1, EP 0 158 165 B1, EP 0 274 068 A2, EP 1 347 549 A1, EP 1 641 895 B1, and DE 196 53 503 A1.

Materials that can be used for purposes according to the invention are known from EP 0061024 A1, EP 0051106 A1, EP 0043952 A1, EP 0158165 A1, EP 0116846 A1, and U.S. Pat. No. 3,396,129 A, as well as EP 1347549 A1. Preferably, the molded body will consist of an intumescence-capable polyurethane foam, as it is known from EP 0061024 A1, DE 3025309 A1, DE 3041731 A1, DE 3302416 A, and DE 3411 327 A1.

In an additional embodiment, the packaging sleeve is a formed plastic part, in particular, a blister pack, as formed plastic parts can be produced cost-effectively.

The packaging sleeve will, e.g., inherently and preferably, be matched to the surface geometry of the molding tool so that the packaging sleeve can be used for shaping the molded foam part.

In an additional embodiment variant, the packaging sleeve is a flexible, i.e., not inherently rigid, flat film. This selection is an especially cost-effective format for the packaging sleeve.

Preferably, the film will be so flexible that it can completely conform to detailed contours of the molding tool so that the shaping of the molded foam part will not be influenced by the packaging sleeve.

In an additional embodiment, the packaging sleeve constitutes the sales packaging, saving the cost for the sales packaging as well as the packaging process for the molded foam parts.

The invention further regards a sales unit having a molded foam part produced according to the method according to the invention, and a packaging sleeve that is also used in production.

### BRIEF DESCRIPTION OF SEVERAL VIEWS OF THE DRAWINGS

Additional characteristics and advantages of the invention will result from the following description as well as from the enclosed drawings referenced. The drawings show the following:

FIG. 1 a cross-sectional view of a molding tool for performing the process according to the invention with an inserted packaging sleeve and introduced foaming material;

FIG. 2 a cross-sectional view of the foaming tool from FIG. 1 in the closed position with foaming material after reaction; and

FIG. 3 a cross-sectional view of the molded foam part removed from the molding tool according to FIG. 2 with its packaging sleeve.

### DETAILED DESCRIPTION OF THE INVENTION

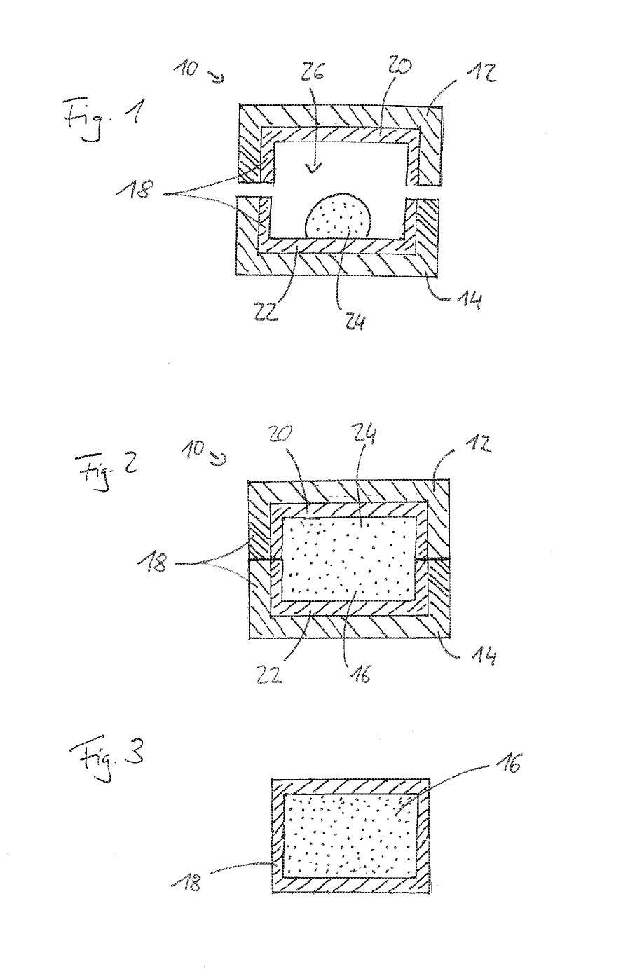

FIG. 1 is a schematic representation of a cross-section of a molding tool 10 having an upper tool part 12 and a lower tool part 14. Upper tool part 12 as well as lower tool part 14 have a cuboid shape, and in each of them, a mold recess has been created. The mold recesses together correspond to a negative mold of molded foam part 16 that is to be produced (FIG. 3). Even though shown here in a schematic manner only, the mold recesses can have detailed contours that allow a detail-rich shape of molded foam part 16.

In molding tool 10, a two-part packaging sleeve 18 is arranged having an upper part 20 and a lower part 22. Upper part 20 is arranged in the mold recess of upper part of tool 12 and can completely cover the surface of the mold recess. Likewise, lower part 22 of packaging sleeve 18 is arranged in the lower part 14 of molding tool 10, and can also cover the entire surface of the mold recess.

Packaging sleeve 18 is, e.g., a flexible, flat film that can conform to the detailed contours of the mold recesses of molding tool 10.

Packaging sleeve 18 can also be a formed plastic part, in particular, a blister pack having inherent rigidity. The molded plastic part may also have detailed contours for shaping molded foam part 16. In addition, the surface geometry of the formed plastic part is matched as packaging sleeve 18 to the surface geometry of molding tool 10.

For producing molded foam part 16, first, packaging sleeve 18 is inserted into molding tool 10.

Then, a flowable foaming material 24 is filled into packaging sleeve 18 in the opened molding tool 10. The opened molding tool 10 with the introduced flowable foaming material 24 is shown in FIG. 1.

Foaming material 24 is a reaction mass containing at least two components that will, e.g., react to become polyurethane foam.

After foaming material 24 has been filled in, molding tool 10 will be closed, which will simultaneously also close packaging sleeve 18. The mold recesses of molding tool 10 and the packaging sleeve 18 arranged therein thus define a cavity 26 in which foaming material 24 is located.

Foaming material 24 will then react, whereby the two components of the foaming material 24 react with each other, creating a foam with a greatly increased volume. During this process, foaming material 24 will fill the entire cavity 26, thus creating molded foam part 16. FIG. 2 shows the closed molding tool 10 with the foaming material 24 after foaming has been completed.

With the molding tool 10 closed, upper part 20 may be fastened to the lower part 22 of the packaging sleeve; e.g., by means of heating up molding tool 10. This will securely seal packaging sleeve 18 (FIG. 3).

After foaming and reaction of foaming material 24 have been completed while creating molded foam part 16, molded foam part 16 can be removed from the mold and molding tool 10 together with packaging sleeve 18. Molded foam part 16 will not adhere to molding tool 10 as molding material 24 has not come in contact with molding tool 10. Consequently, removal from the mold is possible without damaging molded foam part 16 or contaminating molding tool 10 in such a manner that rework on molded foam part 16 or molding tool 10 will not be required.

FIG. 3 shows a cross-sectional view of the sales unit produced, i.e., the molded foam part 16 in its packaging sleeve 18, which has been removed from the mold. Packaging sleeve 18 completely envelops molded foam part 16.

In addition, packaging sleeve 18 can already constitute the sales packaging.

It is understood that the process is not restricted to the shape of molded foam part 16 shown here.

For example, any other shapes that can be produced by means of foaming of molded foam part 16 can also be imagined. In addition, details of molding tool 10, such as means of releasing air, have not been shown either; but a person skilled in the art knows about the exact design of a molding tool for foaming molded foam parts.

What is claimed is:

1. A method for producing a molded foam part, comprising:
inserting, into a molding tool, a packaging sleeve for the molded foam part to be produced;
inserting a flowable foaming material into the packaging sleeve within the molding tool;
forming the molded foam part in the packaging sleeve by foaming the flowable foaming material in the packing sleeve to fill a cavity defined by the molding tool and the packaging sleeve; and
removing the packaging sleeve and the molded foam part within the packaging sleeve from the molding tool.

2. The method of claim 1, wherein the packaging sleeve completely envelops molded foam part.

3. The method of claim 1, wherein said inserting the packaging sleeve comprises:
inserting a first part of the packaging sleeve in a first part of the molding tool; and
inserting a second of the packaging sleeve in a second part of the molding tool.

4. The method of claim 3, further comprising fastening the first part of the packaging sleeve to the second part of the packaging sleeve by heating.

5. The method of claim 1, further comprising closing packaging sleeve with the molding tool.

6. The method of claim 1, further comprising selecting the flowable foaming material from a reaction mass comprising at least two components.

7. The method of claim 6, wherein the reaction mass comprises a foamable binder comprising an intumescent mix of substances.

8. The method of claim 1, wherein the packaging sleeve comprises a plastic part forming a blister pack.

9. The method of claim 8, wherein the packaging sleeve is rigid and conforms to a surface geometry of the molding tool.

10. The method of claim 1, wherein the packaging sleeve comprises a flexible, flat film.

11. The method of claim 10, wherein the film is sufficiently flexible to conform to contours of molding tool.

12. The method of claim 1, wherein packaging sleeve forms sales packaging for the molded foam part.

13. A product comprising a molded foam part and a packaging sleeve produced according claim 1.
